(19) United States
(12) Patent Application Publication
(10) Pub. No.: US 2011/0186030 A1
(43) Pub. Date: Aug. 4, 2011

(54) COOKING OVEN AND METHOD FOR OPERATING THE SAME

(75) Inventors: Richard Turek, Fuerth (DE); Manfred Von Dobschuetz, Langenfeld (DE); Bianca Häeuslein, Schwaebisch Hall (DE); Martin Knausenberger, Rothenburg o.d. Tauber (DE); Kathrin Hildenbrand, Neusitz (DE); Stefan Schlup, Glarus (CH); Christian Staehli, Glarus (CH)

(73) Assignee: ELECTROLUX HOME PRODUCTS CORPORATION N.V., Zaventem (BE)

(21) Appl. No.: 12/530,587

(22) PCT Filed: Mar. 20, 2008
(86) PCT No.: PCT/EP2008/002286

§ 371 Date: Sep. 9, 2009

(30) Foreign Application Priority Data
Mar. 29, 2007 (EP) 07006553.7

(51) Int. Cl. A21B 1/00

(52) U.S. Cl. 126/21 A

(57) ABSTRACT

The invention relates to a cooking oven with a cavity for placing a dish to be cooked, with a first opening in the wall of the cavity at a first location, wherein the first opening can be opened and closed by means of a first valve, wherein a first conduit is arranged adjacent to the first opening leading to a fan element, and with a second opening in the wall of the cavity at a second location, wherein the second opening is in fluidic connection with a fresh air opening which can be opened and closed by means of a second valve, wherein the fresh air opening is in fluidic connection with the ambient of the cooking oven. The invention further relates to and improved a steam cooking process. Furthermore, the invention relates to a method for operating a cooking oven.

The invention relates to a cooking oven, especially to a domestic cooking oven, with a cavity for placing a dish to be cooked, with a first opening in the wall of the cavity at a first location, wherein the first opening can be opened and closed by means of a first valve, wherein a first conduit is arranged adjacent to the first opening leading to a fan element, and with a second opening in the wall of the cavity at a second location, wherein the second opening is in fluidic connection with a fresh air opening which can be opened and closed by means of a second valve, wherein the fresh air opening is in fluidic connection with the ambient of the cooking oven. Furthermore, the invention relates to a method for operating a cooking oven.

It is well known in the art to employ cooking ovens which have classic types of heat introduction into the food to be cooked (convection air created by static heating elements) as well as heat introduction by means of water steam which is injected into the cavity of the oven by a steam generating unit. Thus, an oven supplied with the mentioned heat generation systems can be operated in different cooking modes.

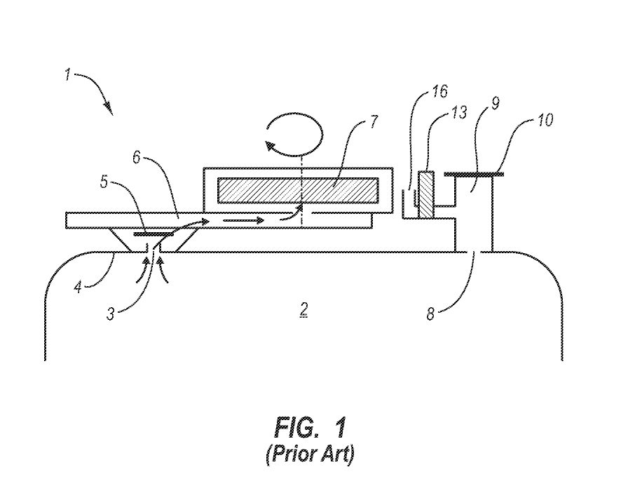

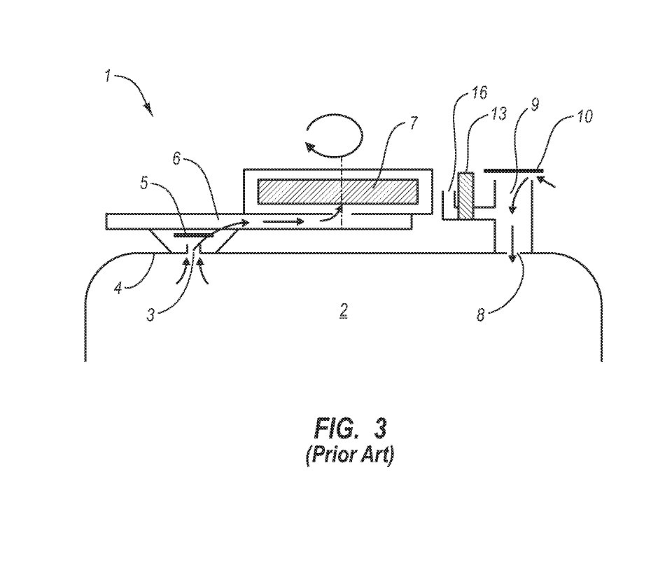

Such an oven according to the state of the art is depicted in FIG. 1 till FIG. 3. The cooking oven 1 has a cavity 2 in which the food to be cooked is placed. In the wall 4 of the cavity 2 a first opening 3 is arranged, wherein this opening can be opened and closed by means of a first valve 5. The first opening 3 leads to a first conduit 6 which in turn leads to a fan element 7.

On the other side—remote from the first opening 3—a second opening 8 is arranged in the wall 4 of the cavity 2. A fresh air opening 9 is arranged adjacent to the second opening 8, wherein the fresh air opening 9 can be opened and closed by a second valve 10.

In FIG. 1 a classical operation mode is shown (using convection air and static heat elements). Here, the first opening 3 is opened and the fan 7 is operated.

The second opening 8 is closed due to the fact that the valve 10 closes the fresh air opening 9. So, used air and vapour is sucked out from the cavity 2 which is illustrated by the arrows in FIG. 1.

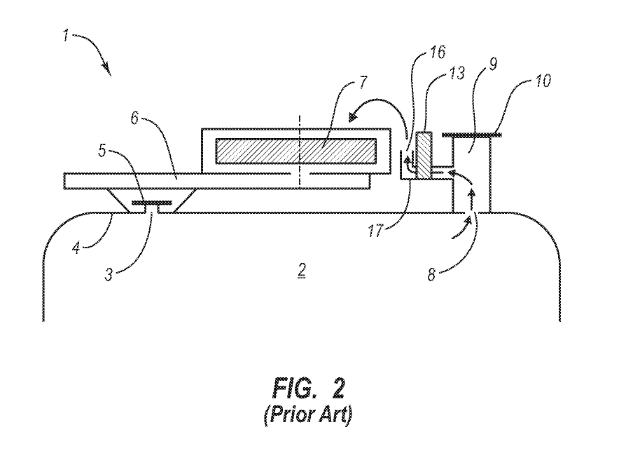

In FIG. 2 the steam operation mode is depicted. Now, both valves 5, 10 are closed so that no steam can escape from the cavity 2. If a pressure exists in the cavity which exceeds the ambient pressure, steam leaves the cavity via an opening 16 at the end of a conduit 17 (see arrows). In the conduit 17 a temperature sensor 13 is arranged to sense the temperature of the steam in the cavity. So, the steam generating unit can be (feed back) controlled in such a way that a desired steam temperature is maintained in the cavity. The fan 7 does not run in this operation mode.

Finally, FIG. 3 shows the operation mode after the steam operation mode has finished, i.e. a steam evacuation mode. Now valves 5 and 10 are opened and the fan 7 is operated. Thus, fresh air enters into the cavity via the openings 9 and 8 and steam is sucked out from the cavity 2 via the opening 3 and the conduit 6 by means of the fan 7.

During the steam operation mode is it detrimental that steam is free along certain distances, so that it is possible that steam can reach the electronic components of the oven. Thus, it is possible that a damage occurs in the electrical system of the oven which causes service costs and displeases the user of the oven.

On the other hand the sensing of the temperature of the steam in the cavity by means of the temperature sensor 13 does not deliver the actual temperature value as only a quite small part of the steam vents via the conduit 17. So the controlling process for the temperature of the steam in the cavity 2 is not optimal. Thus, due to the undefined steam flow through the conduit 17 the measurement of the actual steam temperature in the cavity is complicated.

GB 2 256 921 A shows an oven including a duct for combustion products which extends downwardly around the outside of the oven cavity and which terminates at an opening beneath and at the front of the oven cavity. Furthermore a fan is arranged for driving the combustion products along the duct towards the opening. No specific hints are given to a steam operation mode and how to eliminate the above mentioned problems. Another solution of an oven is shown in EP 1 050 718 B1. Also here, no solution is offered with respect to a steam operating mode and to eliminate the mentioned problems.

Another cooking oven of the above mentioned kind is also known from DE 10 2004 003 409 A1 and from DE 199 39 673 A1.

Therefore, it is an object of the invention to suggest a cooking oven, especially a domestic cooking oven, as well as a respective method for operating the same by which is becomes possible to better protect the sensitive parts of the oven from steam. Furthermore, it is an object of the invention to propose a possibility to easy sense the temperature of the steam in the cavity in a precise way to improve the steam cooking process.

The solution of this object according to the invention is characterized in that the second opening in the wall of the cavity is in fluidic connection with a bypass chamber which in turn is in fluidic connection with the fan element by means of a bypass conduit, wherein a temperature sensor is arranged in the bypass chamber for sensing the temperature of the medium in the bypass chamber and wherein the fan element is in fluidic connection with the first conduit and the bypass conduit via one sucking opening.

By this a better control of the temperature during steam cooking operation becomes possible. Consequently, a preferred embodiment of the invention is characterized in that a steam generating unit is arranged to supply the cavity with water steam.

The second location is preferably remote from the first location.

The power of the fan element is preferably controllable. The fan element is normally electrically driven.

At least one of the valves can be designed to partly open or close the first and second opening respectively.

The method for operating a cooking oven, having a cavity for placing a dish to be cooked, having a first opening in the wall of the cavity at a first location, wherein the first opening can be opened and closed by means of a first valve, wherein a first conduit is arranged adjacent to the first opening leading to a fan element, and having a second opening in the wall of the cavity at a second location, wherein the second opening is in fluidic connection with a fresh air opening which can be opened and closed by means of a second valve, wherein the fresh air opening is in fluidic connection with the ambient of the cooking oven, is characterized in

that water steam is injected into the cavity during a steam operating mode, wherein steam is sucked from the cavity into a bypass chamber by means of the fan element via the second opening and wherein the temperature of the steam is sensed in the bypass chamber by means of a temperature sensor or

that water steam is evacuated from the cavity during a steam evacuation mode, wherein steam is sucked from the cavity via the second opening, via a bypass chamber and via a bypass conduit by means of the fan element, wherein at least one of the valves is opened,

wherein the fan element is in fluidic connection with the first conduit and the bypass conduit via one sucking opening.

Preferably, both valves are closed in the steam cooking mode.

Preferably, both valves are opened in the steam evacuation mode.

Beneficially, the suggested oven and method allow to avoid free steam in the appliance. No dangerous humidity enters into regions of sensitive electronic components of the oven. The humidity can be controlled in the cavity by opening and closing the first and/or second opening.

A flexible use of different operation modes becomes possible. A maximum exhaust operation is possible when the valves are opened.

Energy saving becomes possible. A first possibility of operation is that the first and the second openings are closed during the heating up phase. A second possibility is to close both openings during the cooking cycles. A third possibility is to close the openings partially (50%) during the cooking cycles.

The steam temperature can be controlled using a small amount of volume of steam in the bypass chamber. So, short reaction times in controlling are possible; the controlling of the temperature can be done in a very precise way.

The costs of the appliance can also be reduced due to less parts compared with a pre-known solution.

The maintenance costs are reduced and less problems occur in the field.

In the drawings embodiments of the invention are depicted.

FIG. 1 shows schematically a sectional view through the upper part of a domestic cooking oven according to the state or the art, wherein a classical operation mode is shown using static heating elements (not shown),

FIG. 2 shows the same oven as in FIG. 1 according to the state or the art, wherein a steam operation mode is depicted,

FIG. 3 shows the same oven as in FIG. 2 according to the state or the art, wherein a steam evacuation mode is illustrated,

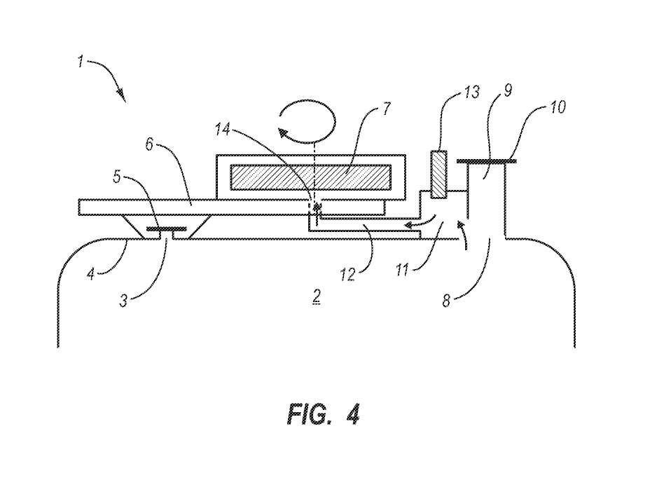

FIG. 4 shows schematically a sectional view through the upper part of a domestic cooking oven according to an embodiment of the invention, wherein a steam operation mode is depicted,

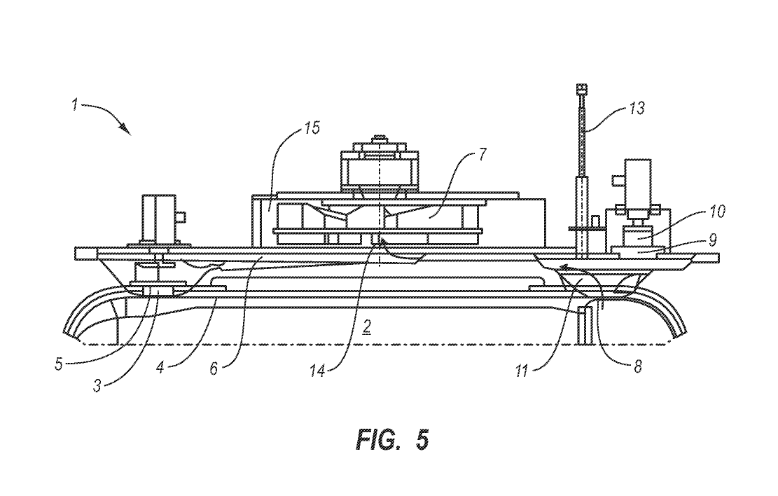

FIG. 5 shows a more realistic sectional view of the oven according to an embodiment of the invention, wherein a steam operation mode is depicted,

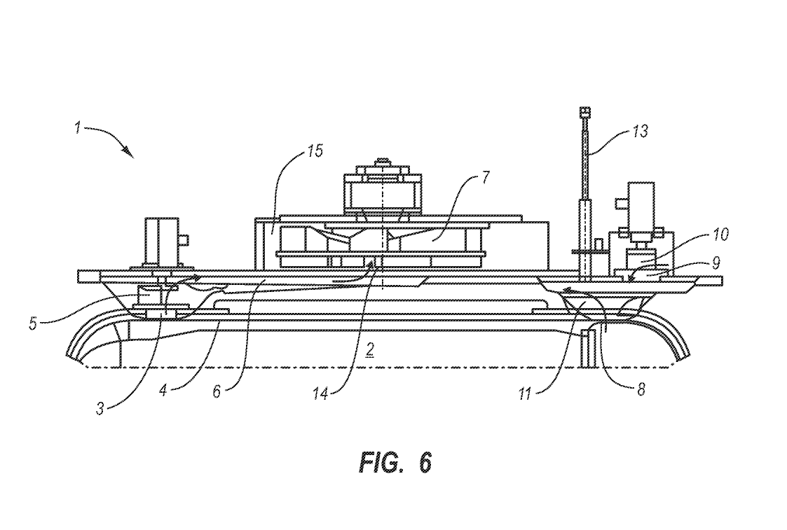

FIG. 6 shows the oven according to FIG. 5, wherein the steam evacuation

operation mode is depicted, and

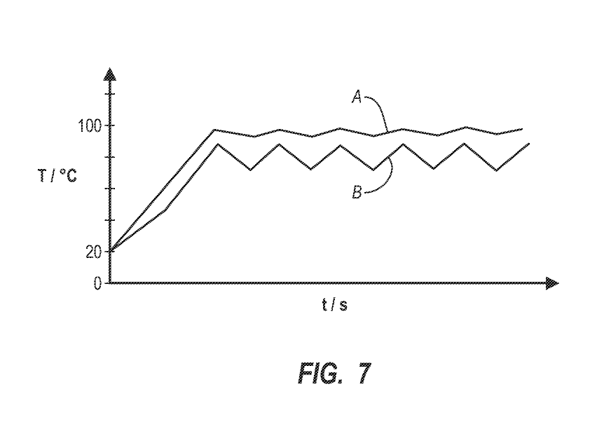

FIG. 7 shows a Temperature-Time diagram for the heating up of the cavity and the steam operation mode.

Referring now to FIG. 4 a domestic cooking oven 1 is shown in a schematic view. With regard to the different components reference is made to the explanation of FIG. 1 till FIG. 3; the same reference numerals are used in all figures.

The proposed cooking oven 1 according to the invention comes up with the fact that the second opening 8 is in fluidic connection with a bypass chamber 11 which in turn is in fluidic connection with the fan element 7 by means of a bypass conduit 12. Furthermore, a temperature sensor 13 is arranged in the bypass chamber 11 for sensing the temperature of the medium in the bypass chamber 11, i.e. of the steam which is injected into the cavity by a (not shown) steam generating unit.

The first conduit 6 and the bypass conduit 12 discharge substantially at the same location in the operation area of the fan element 7. That means that one single sucking opening 14 is arranged for both conduits 6 and 12 which lead to the fan 7.

During the steam operating mode as depicted in FIG. 4 both valves 5 and 10 are closed. Due to an overpressure in the cavity 2 on one hand side as well as due to the operation of the fan 7 on the other side steam is sucked in the bypass chamber 11 where a temperature sensor 13 is arranged. As a certain flow of steam through the bypass chamber 11 is maintained it is possible to quite precisely measure the temperature of the steam in the cavity 2.

Furthermore, as steam is sucked off from the cavity 2 by means of the fan 7, no “free” steam exists which can migrate to sensitive electronic parts of the oven and destroy them.

Consequently, the oven can be better protected and a failure of the cooking oven is reduced.

In FIG. 5 and FIG. 6 a more realistic embodiment of the cooking oven 1 according to the invention is depicted. The steam is sucked out from the cavity 2 by means of the fan 7 which has a cooling channel 15 via which the exhaust takes place.

The suggested oven allows—as in the prior art—at least the three different operation modes:
normal cooking (using e.g. convection air generated by static heating elements),
steam cooking using hot water steam (wet steam below 100° C. or hot steam above 100° C.) and
evacuation of the steam from the cavity.

It becomes easily possible to control the steam temperature with the overpressure steam leaving the cavity.

During the normal cooking mode the fan 7 creates a pressure in the cavity 2 below the pressure of the ambient. Consequently, vapour is sucked out from the cavity 2 via the first opening 3 as the valve 5 is opened. Fresh air coming from the housing of the appliance enters via the fresh air opening 9.

During steam cooking (FIG. 4 and FIG. 5) the first valve 5 and the second valve 10 is closed. Steam is injected into the cavity 2 via a steam generating unit. If the pressure in the cavity is higher as the pressure of ambient and/or if the fan 7 is operated steam leaves the cavity 2 via the second opening 8 and enters into the bypass chamber 11. Here, the temperature of the steam is sensed by means of the temperature sensor 13. Thus, the sensor 13 senses the temperature of the small volume of steam which is in the bypass chamber 11. Using the sensed temperature signal the injection and/or temperature of the steam injected into the cavity can be feed back controlled by a control system (not shown).

The temperature of the small volume of steam in the bypass chamber 11 drops faster than the bigger volume of steam in the cavity 2. This situation is depicted in FIG. 7. Here, the run of the temperature T along the time t is shown. The upper graph A shows the temperature of the steam in the cavity, the lower graph B shows the temperature of the steam in the bypass chamber 11. The zigzag curve shows the result of controlling the temperature at a certain level. As can be seen the variation of the temperature in the cavity is smaller than that one of the temperature in the bypass chamber. Thus, is becomes possible to quit precisely control the temperature in the cavity within a tolerance of +/−1° C.

During the steam evacuation operation both valves 5, 10 are opened and the fan 7 is operated with increased power (e.g. with plus 100% power compared with the operation mode during conventional operation).

With the suggested system it is possible to create special energy saving modes for special recipes. With a small amount of exhaust volume there is also a small energy loss by evacuating hot air from the cavity 2.

### REFERENCE NUMERALS

1 Cooking oven (domestic cooking oven)
2 Cavity
3 First opening
4 Wall of the cavity
5 First valve
6 First conduit
7 Fan element
8 Second opening
9 Fresh air opening
10 Second valve
11 Bypass chamber
12 Bypass conduit
13 Temperature sensor

1.-9. (canceled)

10. A cooking oven, wherein the oven includes a cavity for placing a dish to be cooked, the oven comprising:
a first opening in the wall of the cavity at a first location, wherein the first opening is opened and closed by means of a first valve and a first conduit is arranged adjacent to the first opening leading to a fan element; and
a second opening in the wall of the cavity at a second location, wherein:
the second opening is in fluidic connection with a fresh air opening which is opened and closed by means of a second valve;
the fresh air opening is in fluidic connection with the ambient of the cooking oven;
the second opening is in fluidic connection with a bypass chamber which is in fluidic connection with the fan element by means of a bypass conduit;
a temperature sensor is arranged in the bypass chamber for sensing the temperature of the medium in the bypass chamber; and
the fan element is in fluidic connection with the first conduit and the bypass conduit via one sucking opening.

11. A cooking oven according to claim 10, wherein a steam generating unit is arranged to supply the cavity with water steam.

12. A cooking oven according to claim 10, wherein the second location is remote from the first location.

13. A cooking oven according to claim 10, wherein the power of the fan element is controllable.

14. A cooking oven according to claim 10, wherein the fan element is electrically driven.

15. A cooking oven according to claim 10, wherein at least one of the valves is designed to partly open or close the first and second opening respectively.

16. A method for operating a cooking oven, having a cavity for placing a dish to be cooked, the oven including a first opening in the wall of the cavity at a first location, wherein the first opening can be opened and closed by means of a first valve, wherein a first conduit is arranged adjacent to the first opening leading to a fan element, and having a second opening in the wall of the cavity at a second location, wherein the second opening is in fluidic connection with a fresh air opening which can be opened and closed by means of a second valve, wherein the fresh air opening is in fluidic connection with the ambient of the cooking oven, wherein the fan element is in fluidic connection with the first conduit and the bypass conduit via one sucking opening, the method comprising:
injecting water steam into the cavity during a steam operating mode, wherein steam is sucked from the cavity into a bypass chamber via a bypass conduit by means of the fan element via the second opening and wherein the temperature of the steam is sensed in the bypass chamber by means of a temperature sensor; and
evacuating water steam from the cavity during a steam evacuation mode, wherein steam is sucked from the cavity via the second opening, via a bypass chamber and via a bypass conduit by means of the fan element, wherein at least one of the valves is opened.

17. A method according to claim 16, wherein both valves are closed in the steam cooking mode.

18. A method according to claim 16, wherein both valves are open in the steam evacuation mode.
